(19) United States
(12) Patent Application Publication
(10) Pub. No.: US 2015/0338903 A1
(43) Pub. Date: Nov. 26, 2015

(54) DISPLAY APPARATUS, DISPLAY METHOD, AND PROGRAM

(71) Applicant: SEIKO EPSON CORPORATION, Tokyo (JP)

(72) Inventor: Takeshi WADA, Shiojiri-shi (JP)

(21) Appl. No.: 14/719,083

(22) Filed: May 21, 2015

(30) Foreign Application Priority Data
May 22, 2014 (JP) 2014-106396

(51) Int. Cl. G06F 1/32; G06F 3/041

(52) U.S. Cl. CPC G06F 1/3265; G06F 3/0416; G06F 1/3287

(57) ABSTRACT

Upon completion of rewriting of a page of a document, a display apparatus having a display unit with memory switches to a low power consumption mode without rewriting the display on a display unit, and stops power supply to the display unit. When a page updating operation is performed in the low power consumption mode, the display apparatus supplies power to the display unit, and rewrites the display screen with the screen of the next page.

### BACKGROUND

1. Technical Field

The present invention relates to a display apparatus, a display method, and a program.

2. Related Art

Examples of technologies aiming to reduce the power consumption by suspending the processing relating to the display include a technology adopted in a portable device disclosed in JP-A-2007-41143. This portable device aims to reduce the power consumption by holding the data of a displayed image in a display memory and suspending the rendering of the image. When recovering from the power saving state to the normal usage state, the portable device re-renders the image data held in the display memory. Since the same screen that the user was viewing is displayed again by the portable device recovering from the power saving state to the normal usage state, the user does not feel uncomfortable.

Meanwhile, some portable devices, such as electronic book readers, are equipped with a display with electronic paper utilizing electrophoretic technology and having memory. When the display of a portable device is an electronic paper display, even when power supply to the display is suspended, the display holds the image that was being displayed immediately before the suspension. In this case, for example, when an operation for turning a page is performed when the portable device is displaying a document in the power saving state, it is preferable that the portable device displays the next page.

However, according to the configuration of the portable device disclosed in JP-A-2007-41143, when the portable device recovers from the power saving state to the normal usage state, the portable device re-renders the same image as the image that was being displayed. That is, although the operation for turning a page is performed, the device does not display the next page. This is inconvenient for the user.

### SUMMARY

An advantage of some aspects of the invention is to, when an apparatus having a display with memory recovers from a low power consumption mode according to a user operation, display an image corresponding to the operation.

One aspect of the invention provides a display apparatus having: a memory display unit; an operation unit operated by a user; a control unit that executes an operating system and an application for displaying a document. A mode is selected from among a third mode in which power is supplied to the memory display unit, a first mode in which power supply to the memory display unit is stopped, and a second mode in which power supply to the memory display unit is stopped and in which a power consumption is smaller than in the first mode. The operating system, when an operation for replacing a page of the document displayed on the memory display unit is performed on the operation unit in the first mode, selects the third mode and supplies power to the memory display unit, and sends an event corresponding to the operation to the application. The operating system, when an operation for switching to the third mode is performed on the operation unit in the second mode, selects the third mode and supplies power to the memory display unit. The application, upon acquisition of the event, performs processing for displaying another page on the memory display unit.

According to this aspect of the invention, when an apparatus having a display with memory recovers from a low power consumption mode according to a user operation, the apparatus can display an image corresponding to the operation.

Another aspect of the invention provides a display apparatus comprising: a memory display unit; an operation unit operated by a user; a control unit that executes an operating system and an application for displaying a document. A mode is selected from among a third mode in which power is supplied to the memory display unit, a first mode in which power supply to the memory display unit is stopped, and a second mode in which power supply to the memory display unit is stopped and in which a power consumption is smaller than in the first mode. The operating system, when an operation for switching from the first mode or the second mode to the third mode is performed on the operation unit, supplies power to the memory display unit, and calls a callback function of the application. The operating system, when an operation for replacing a page of the document displayed on the memory display unit is performed, sends an event corresponding to the operation to the application. The application, when the mode at the time the callback function is called is the second mode, selects the third mode, performs processing for displaying a screen that was being displayed on the memory display unit when the second mode was selected. The application, when the mode at the time the callback function is called is the first mode, selects the third mode. The application, when acquiring the event, performs processing for displaying another page on the memory display unit.

According to this aspect of the invention, when an apparatus having a display with memory recovers from a low power consumption mode according to a user operation, the apparatus can display an image corresponding to the operation.

It is preferable that switching from the third mode to the first mode is performed after the processing for displaying another page on the memory display unit is performed.

According to this configuration, switching to the first mode occurs when the page to be displayed is replaced, thereby reducing the power consumption of the display apparatus.

It is preferable that switching from the third mode to the first mode is performed when predetermined time has elapsed since the processing for displaying another page on the memory display unit was performed, the predetermined time being time required for displaying the other page.

According to this configuration, in the case of performing processing for displaying another page and switching to the first mode occurs, the switching to the first mode does not occur until the completion of the processing for displaying the other page. Therefore, the processing for displaying the other page can be surely performed.

It is preferable that a plurality of methods are provided for rewriting a screen displayed on the memory display unit, each method being different in rewriting time, and the predetermined time is changed according to a method selected from among the plurality of method.

According to this configuration, the processing for displaying another page can be surely performed even when the method for rewriting the screen is changed.

Yet another aspect of the invention provides a display method including: selecting a mode from among a third mode in which power is supplied to a memory display unit, a first mode in which power supply to the memory display unit is stopped, and a second mode in which power supply to the memory display unit is stopped and in which a power consumption is smaller than in the first mode. An operating system, when an operation for replacing a page of a document displayed on the memory display unit is performed on an operation unit in the first mode, selects the third mode and supplies power to the memory display unit, and sends an event corresponding to the operation to an application. The operating system, when an operation for switching to the third mode is performed on the operation unit in the second mode, selects the third mode and supplies power to the memory display unit. An application for displaying a document, upon acquisition of the event, performs processing for displaying another page on the memory display unit.

According to this aspect of the invention, when an apparatus having a display with memory recovers from a low power consumption mode according to a user operation, the apparatus can display an image corresponding to the operation.

Yet another aspect of the invention provides a program for causing a computer to implement an operating system that, when an operation for replacing a page of a document displayed on a memory display unit is performed on an operation unit in a first mode in which power supply to the memory display unit is stopped, selects a third mode in which power is supplied to the memory display unit, supplies power to the memory display unit, and sends an event corresponding to the operation to an application for displaying a document, and when an operation for switching to the third mode is performed on the operation unit in a second mode in which power supply to the memory display unit is stopped and in which a power consumption is smaller than in the first mode, selects the third mode and supplies power to the memory display unit.

According to this aspect of the invention, when an apparatus having a display with memory recovers from a low power consumption mode according to a user operation, the apparatus can display an image corresponding to the operation.

Yet another aspect of the invention provides a program for causing a computer to implement an application that operates as follows: when a mode at the time a callback function is called is a first mode, selects a third mode: when the mode at the time the callback function is called is a second mode, selects the third mode and performs processing for displaying a screen that was being displayed on the memory display unit when the second mode was selected; and when acquiring an event, performs processing for displaying another page on the memory display unit. The first mode is a mode in which power supply to the memory display unit is stopped. The second mode is a mode in which power supply to the memory display unit is stopped and in which a power consumption is smaller than in the first mode. The third mode is a mode in which power is supplied to the memory display unit. The callback function is called at switching to the third mode. The event is sent from an operating system when an operation for replacing a page of a document displayed on the memory display unit is performed.

According to this aspect of the invention, when an apparatus having a display with memory recovers from a low power consumption mode according to a user operation, the apparatus can display an image corresponding to the operation.

### BRIEF DESCRIPTION OF THE DRAWINGS

The invention will be described with reference to the accompanying drawings, wherein like numbers reference like elements.

FIG. 1 is a diagram showing a display apparatus 10 according to an embodiment of the invention.

FIG. 2 is a diagram showing a hardware configuration of the display apparatus 10.

FIG. 3 is a diagram showing a relationship between a voltage applied to a pixel and a tone value of the pixel.

FIGS. 4A and 4B are diagrams showing an example of the contents of a first LUT 1061.

FIGS. 5A and 5B are diagrams showing an example of the contents of a second LUT 1062.

FIG. 6 is a diagram showing a change in the tone value in the case of a first method.

FIG. 7 is a diagram showing a change in the tone value in the case of a second method.

FIG. 8 is a functional block diagram of the display apparatus 10.

FIG. 9 shows an example of a screen displayed by a display unit 107.

FIG. 10 is a flowchart showing operation performed by a control unit 100.

FIG. 11 is a flowchart showing operation performed by the control unit 100.

FIG. 12 is a diagram showing a display apparatus 10A and a display apparatus 10B according to a second embodiment of the invention.

### DESCRIPTION OF EXEMPLARY EMBODIMENTS

### Embodiment

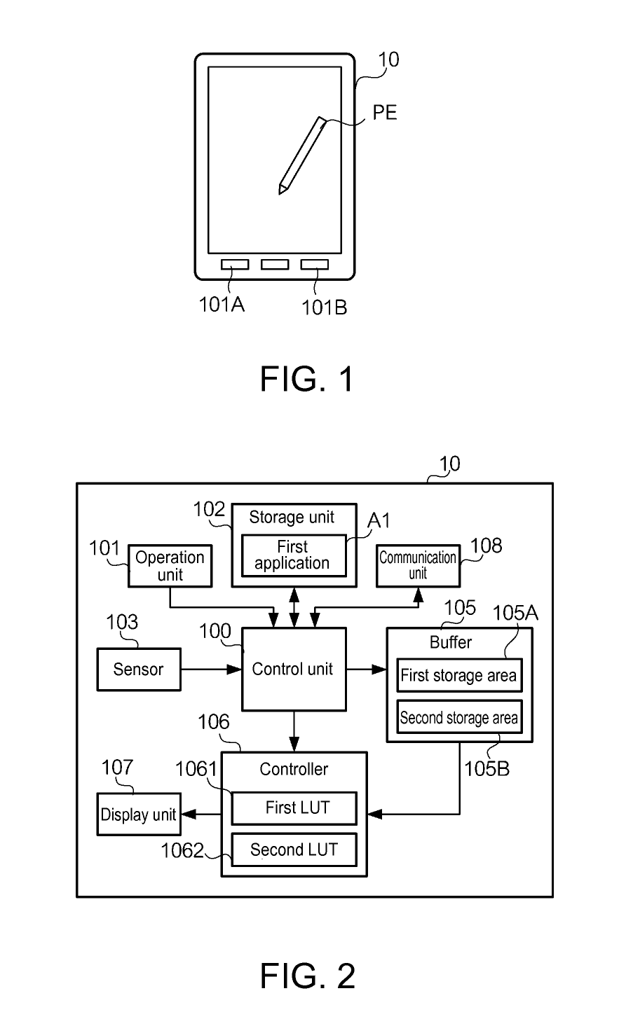

FIG. 1 is a diagram showing a display apparatus 10 according to an embodiment of the invention. The display apparatus 10 includes an electrophoretic display device, and has the function of displaying a document corresponding to a document file. One example of document file formats that the display apparatus 10 can process is Portable Document Format (PDF). However, the document format is not limited to PDF, and may be another format.

The display apparatus 10 includes a sensor that detects, at predetermined intervals, the coordinates of a stylus pen PE touching a display surface where an image is displayed. The display apparatus 10 specifies an instruction from the user based on the coordinates detected by the sensor and on a user interface image that is being displayed, and performs operation according to the instruction from the user. The display apparatus 10 also has buttons used for operating the display apparatus 10, and performs operation corresponding to the button operated.

Configuration of Display Apparatus 10

FIG. 2 shows a hardware configuration of the display apparatus 10. A display unit 107 has electronic paper using electrophoretic technology. The electronic paper has pixels arrayed in a plurality of rows and columns, and displays images with multiple tones (i.e., grayscale). The electronic paper has a plurality of microcapsules each enclosing negatively-charged white electrophoretic particles and positively-charged black electrophoretic particles. The microcapsules are sandwiched between a transparent common electrode, which is located on the display surface side of the electronic paper, and pixel electrodes, which are located on the rear side, one for each pixel. The common electrode is maintained at a fixed potential. When a positive voltage is applied to the pixel electrodes with the common electrode being fixed at the constant potential, the positively-charged black electrophoretic particles move toward the display surface. When a negative voltage is applied to the pixel electrodes with the common electrode being fixed at the constant potential, the negatively-charged white electrophoretic particles move toward the display surface. The display unit 107 is an exemplary display unit that holds the image displayed even when power is not supplied, that is, an exemplary memory display unit provided with a display area having memory. Note that the display unit 107 may be electronic paper using a quick-response liquid-powder display (QR-LPD®) technology.

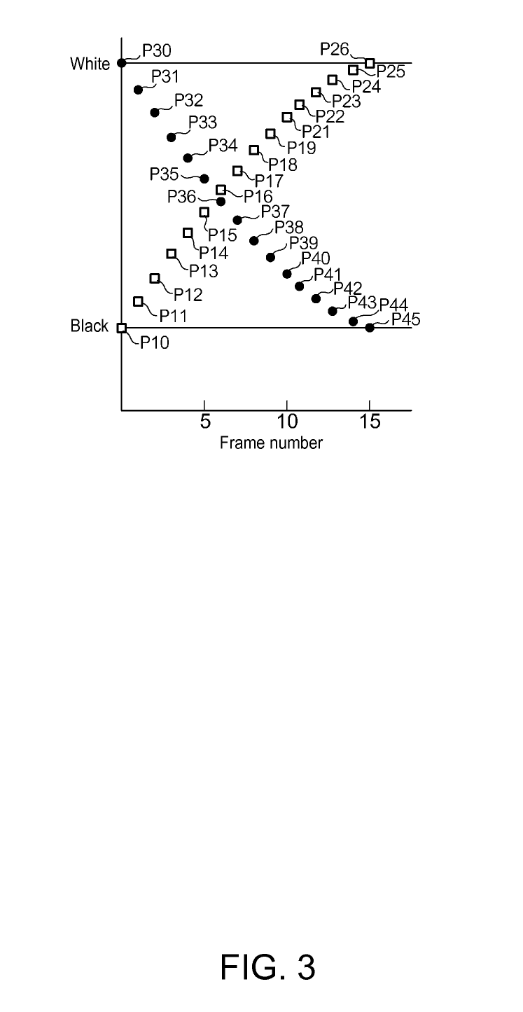

FIG. 3 is a diagram showing the relationship between the voltage applied to a pixel of the display unit 107 and the tone value of the pixel after the application of the voltage. In FIG. 3, the horizontal axis shows the number of frames for which the voltage is applied, and the vertical axis shows the tone value of the pixel. Note that “frame” is a unit of time for which the voltage is applied, and the length thereof in the present embodiment is determined in advance. In the display unit 107, the minimum tone value corresponds to black, and the maximum tone value corresponds to white.

For example, assume a case of applying a voltage to a pixel in order to cause the pixel to change the tone value thereof from the minimum tone value to the maximum tone value. The initial state before the voltage application, in which the tone of the pixel is black, is represented by point P10. From this point, when a predetermined first voltage (e.g., −15 V) is applied for one frame period to the pixel electrode, the white electrophoretic particles move toward the display surface, and the tone of the pixel becomes slightly brighter, which is represented by the transition to point P11. When the first voltage is applied for another one frame period, the tone of the pixel becomes even brighter, which is represented by the transition to point P12. Then, the tone of the pixel sequentially changes from point P13 to point P26 while the first voltage is being applied in this way. The point P26 corresponds to the maximum tone value, which expresses white. In this example, the tone of the pixel gradually changes from black to white while the first voltage is being applied throughout 15 frame periods.

Next, assume a case of applying a voltage to a pixel in order to cause the pixel to change the tone value thereof from the maximum tone value to the minimum tone value. The initial state before the voltage application, in which the tone of the pixel is white, is represented by point P30. From the state represented by the point P30, when a predetermined second voltage (e.g., +15 V) is applied for one frame period to the pixel electrode, the black electrophoretic particles move toward the display surface, and the tone of the pixel becomes slightly darker, which is represented by the transition to point P31. When the second voltage is applied for another one frame period, the tone of the pixel becomes even darker, which is represented by the transition to point P32. Then, the tone of the pixel sequentially changes from point P33 to point P45 while the second voltage is being applied in this way. The point P45 corresponds to the minimum tone value, which expresses black. In this example, the tone of the pixel gradually changes from white to black while the second voltage is being applied throughout 15 frame periods.

As shown in FIG. 3, regarding the tone of each pixel of the display unit 107, the course of transition from white to black is different from the course of transition from black to white. For example, when the electrophoretic layer of a pixel having the minimum tone value is applied with the first voltage six times, the tone of the pixel changes to the state represented by the point P16. However, when the electrophoretic layer of a pixel in the state represented by the point P16 is applied with the second voltage six times, the tone does not change in the order of P15, P14, P13, P12, P11, and P10, and does not change back to the state with the minimum tone value represented by the point P10. For this reason, in the case of displaying an intermediate tone in the present embodiment, first, the first voltage is applied for 15 frame periods so that the tone of the pixel changes to white, and then the second voltage is applied the number of times that corresponds to the tone to be displayed. In the case of rewriting one intermediate tone with another intermediate tone, first, the second voltage is applied so that the tone of the pixel changes to black, then the first voltage is applied throughout 15 frame periods so that the tone of the pixel changes to white, and finally the second voltage is applied the number of times that corresponds to the tone to be displayed.

A sensor 103 is a sensor detecting the coordinates of the tip of the stylus pen PE and the pen pressure. Note that the stylus pen PE and the sensor 103 in the present embodiment may be realized with commonly known elements such as the position indicator and position detecting apparatus disclosed in JP-A-2010-117943 for example. The sensor 103 detects, at regular intervals, the coordinates of the tip of the stylus pen PE on the display area of the display unit 107, and the pressure (pen pressure) acting on the tip of the stylus pen PE. The period of the detection cycle of the sensor 103 is within the range of several milliseconds to several tens of milliseconds. In the present embodiment, the period is set to 10 msec. The sensor 103 outputs a pair of first data and second data to the control unit 100. The first data indicates the detected coordinates, and the second data indicates the detected pressure.

A buffer 105 includes a first storage area 105A and a second storage area 105B. The first storage area 105A is an area for storing the data of a screen to be displayed by the display unit 107. The first storage area 105A has a plurality of storage segments, one for each pixel of the display unit 107. Data indicating the tone value of a pixel is written by the control unit 100 into the storage segment corresponding to the pixel. The second storage area 105B is an area for storing the data of a screen that was being displayed by the display unit 107 before the rewriting of the screen. The second storage area 105B has a plurality of storage segments, one for each pixel of the display unit 107, and each storage segment stores the tone value of the corresponding pixel. Data indicating the tone value of a pixel is written by the control unit 100 into the storage segment corresponding to the pixel.

A controller 106 is a circuit for driving the display unit 107. The controller 106 in the present embodiment is provided with, as methods of driving the display unit 107, a first method for expressing two tones after the rewriting, and a second method for expressing 16 tones after the rewriting. The controller 106 switches between the first method and the second method according to the contents of the area to be rewritten. The controller 106 has look up tables (LUT) used for driving according to either the first method or the second method. LUT is a table for storing information specifying the voltage to be applied in each frame period. The controller 106 has a first LUT 1061 corresponding to the first method and a second LUT 1062 corresponding to the second method.

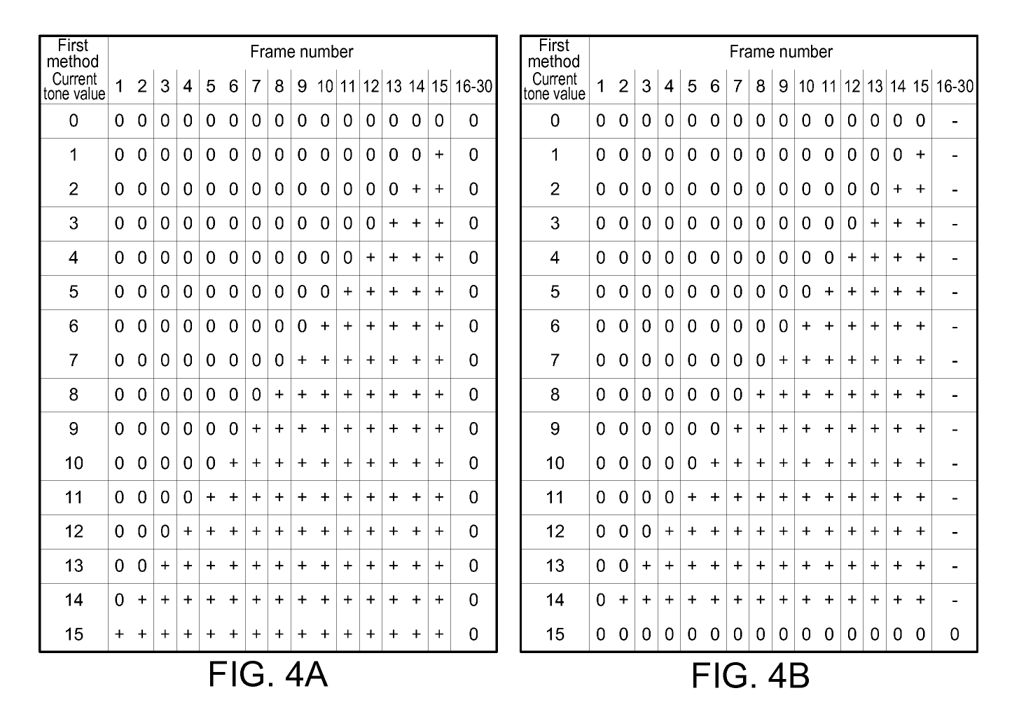

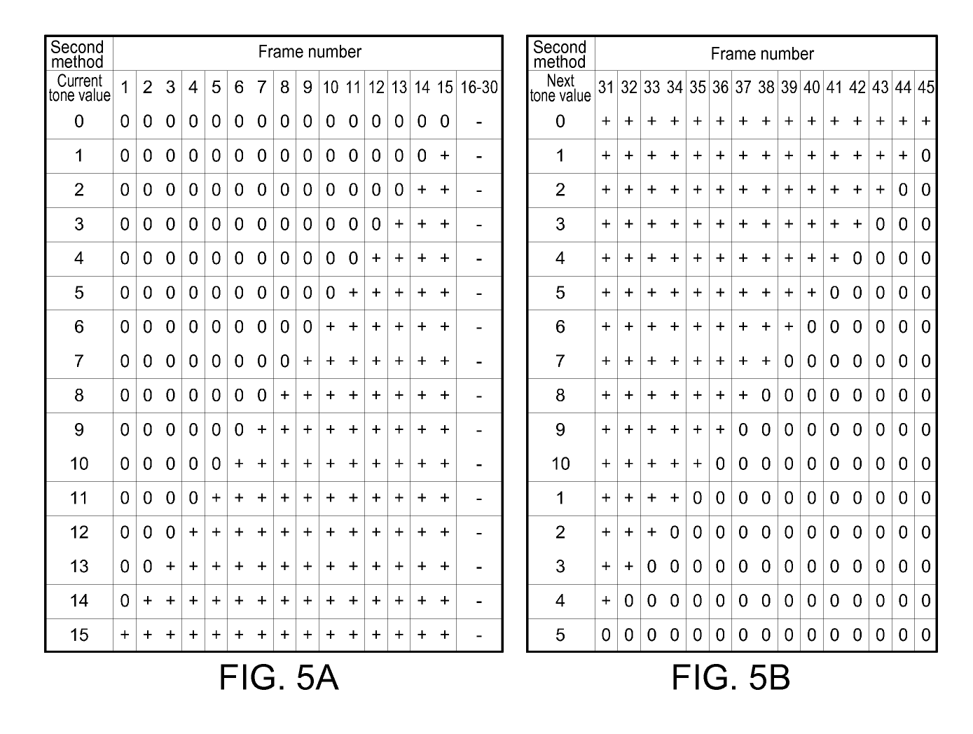

FIGS. 4A and 4B are diagrams showing an example of the contents of the first LUT 1061, and FIG. 5A and FIG. 5B are diagrams showing an example of the contents of the second LUT 1062. In these tables, each of the values 0 to 15 shown in the columns of “current tone value” and “next tone value” indicates the tone value of the pixel. Also, in these tables, “+” represents that the voltage applied to the pixel electrode during one frame period is a positive voltage (+15 V), and “−” represents that the voltage applied to the pixel electrode during one frame period is a negative voltage (−15 V). “0” in the columns of frame numbers represents that the voltage applied to the pixel electrode is maintained at the same potential as the common electrode.

When driving a pixel, the controller 106 acquires the data stored in the buffer 105, and based on the acquired data and the LUTs, the controller 106 applies the first voltage (e.g., −15 V), the second voltage (e.g., +15 V), or a voltage for discharging (0 V) to the pixel electrode during a predetermined number of frame periods. The pattern of the values of the voltage to be applied to the pixel electrode throughout a plurality of frame periods in order to change the tone value of the pixel varies depending on the tone value of the pixel before the rewriting and the tone value of the pixel to be expressed next. It can be said that the pattern of the values of the voltage to be applied to the pixel electrode represents the temporal change of the voltage to be applied. In this meaning, the pattern of the values of the voltage to be applied is referred to as “driving waveform” in the following description.

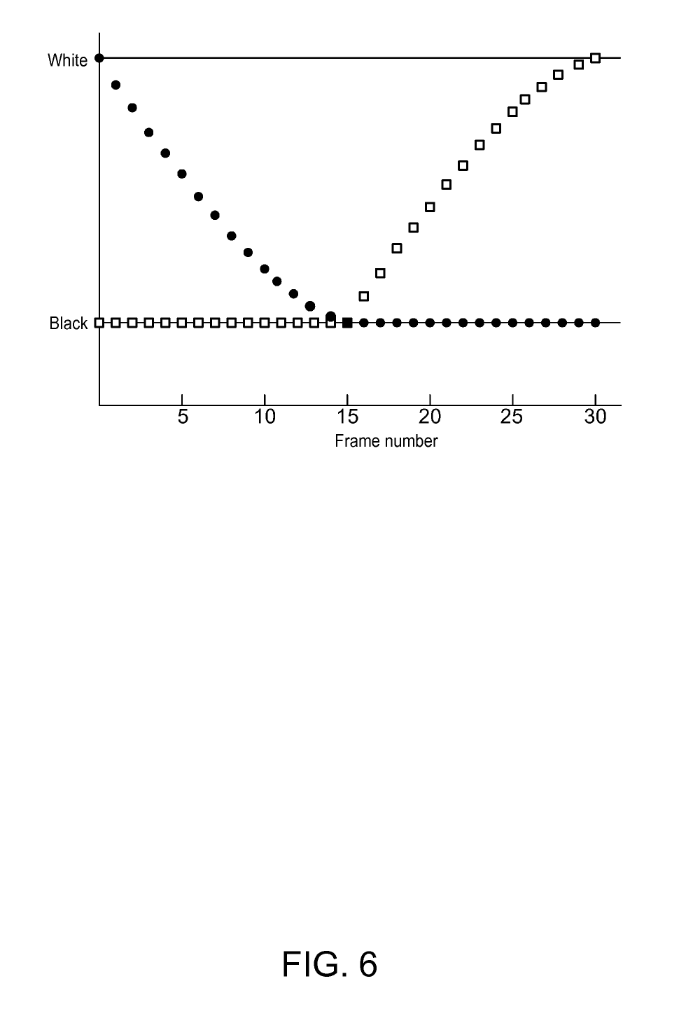

FIG. 6 is a diagram showing an example of the change in the tone value of a pixel in the case where the tone value of the pixel is changed to the minimum tone value or to the maximum tone value by the first method according to the present embodiment. In FIG. 6, the horizontal axis shows the number of frames and the vertical axis shows the tone value of the pixel. When changing the tone value of a pixel by the first method, the controller 106 first binarizes the data acquired from the first storage area 105A. Specifically, when the value of the data acquired from the first storage area 105A is from 0 to 7, the controller 106 determines the value of the acquired data to be 0, and when the value of the acquired data is from 8 to 15, the controller 106 determines the value to be 15.

When the value of the binarized data is 0, the controller 106 applies a voltage to the pixel electrode by referring to the table shown in FIG. 4A. For example, with respect to a given pixel, when the value of the data stored in the second storage area 105B is 15 and the value of the binarized data is 0, the controller 106 refers to the row corresponding to the current tone value “15” in the table shown in FIG. 4A, and applies the positive voltage during the period from the 1^{st} frame to the 15^{th} frame, and discharges the pixel during the period from the 16^{th} frame to the 30^{th} frame. Consequently, as represented by “” in FIG. 6, the tone value of the pixel gradually decreases during the period from the 1^{st} frame to the 15^{th} frame, and the tone value is maintained at the minimum value during the period from the 16^{th} frame.

When the value of the binarized data is 15, the controller 106 applies a voltage to the pixel electrode by referring to the table shown in FIG. 4B. For example, when the value of the data stored in the second storage area 105B is 0, and the value of the binarized data is 15, the controller 106 refers to the row corresponding to the current tone value “0” in the table shown in FIG. 4B, and discharges the pixel during the period from the 1^{st} frame to the 15th frame, and applies the negative voltage to the pixel during the period from the 16th frame to the 30th frame. Consequently, as represented by “□” in FIG. 6, the tone value of the pixel is maintained at the minimum value during the period from the 1^{st} frame to the 15^{th} frame, and the tone value is gradually increased during the period from the 16^{th} frame to the 30^{th} frame.

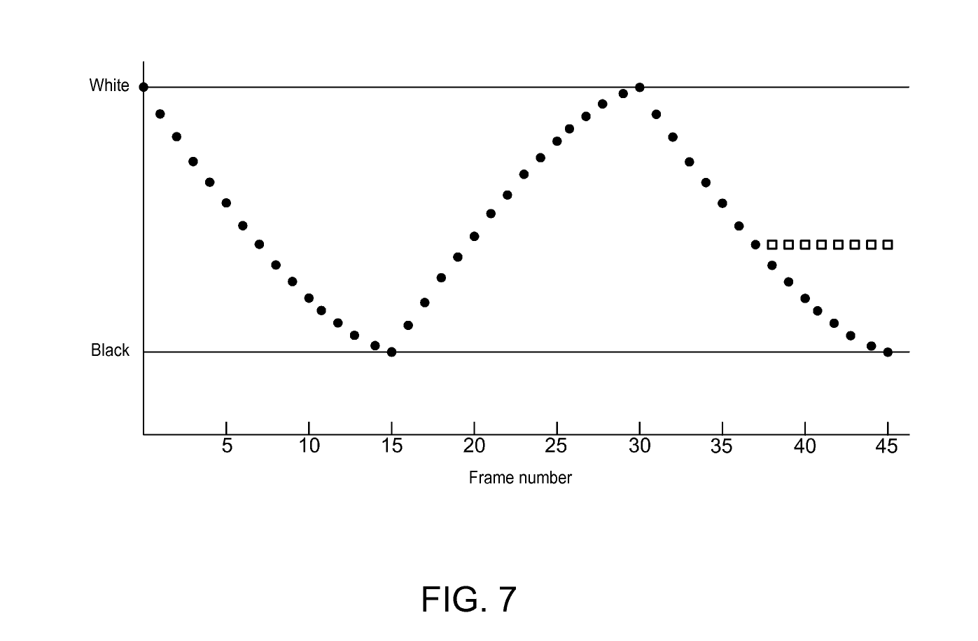

FIG. 7 is a diagram showing an example of the change in the tone value of a pixel in the case where the tone value of the pixel is rewritten by using the second method according to the present embodiment. In FIG. 7, the horizontal axis shows the number of frames and the vertical axis shows the tone value of the pixel. When rewriting the tone value of a pixel by the second method, the controller 106 first acquires data from the first storage area 105A and the second storage area 105B. During the period from the 1^{st} frame to the 30^{th} frame, the controller 106 refers to the table shown in FIG. 5A to apply a voltage to the pixel electrode. During the period from the 31^{st} frame to the 45^{th} frame, the controller 106 refers to the table shown in FIG. 5B to apply a voltage to the pixel electrode.

For example, with respect to a given pixel, when the value of the data stored in the second storage area 105B is 15 and the value of the data stored in the first storage area 105A is 0, in other words, when rewriting the tone of the pixel from white to black, the controller 106 refers to the row corresponding to the current tone value “15” in the table shown in FIG. 5A, and applies the positive voltage to the pixel electrode during the period from the 1^{st} frame to the 15^{th} frame, and applies the negative voltage to the pixel electrode during the period from the 16^{th} frame to the 30^{th} frame. With respect to the period from the 31^{st} frame to the 45^{th} frame, the controller 106 refers to the row corresponding to the next tone value “0” in the table shown in FIG. 5B, and applies the positive voltage to the pixel electrode. Consequently, as represented by “” in FIG. 7, the tone value of the pixel gradually decreases during the period from the 1^{st} frame to the 15^{th} frame, the tone value of the pixel gradually increases during the period from the 16^{th} frame to the 30^{th} frame, and then the tone value of the pixel gradually decreases during the period from the 31^{st} frame to the 45^{th} frame.

Also, for example, with respect to a given pixel, when the value of the data stored in the second storage area 105B is 15 and the value of the data stored in the first storage area 105A is 7, in other words, when rewriting the tone of the pixel from white to an intermediate tone, the controller 106 refers to the row corresponding to the current tone value “15” in the table shown in FIG. 5A, and applies the positive voltage to the pixel electrode during the period from the 1^{st} frame to the 15^{th} frame, and applies the negative voltage to the pixel electrode during the period from the 16^{th} frame to the 30^{th} frame. The controller 106 also refers to the row corresponding to the next tone value “7” in the table shown in FIG. 5B, and applies the positive voltage to the pixel electrode during the period from the 31^{st} frame to the 37^{th} frame, and discharges the pixel during the period from the 38^{th} frame to the 45^{th} frame. Consequently, as shown in FIG. 7, during the period until the 37^{th} frame, the tone of the pixel changes in the same manner as in the case of rewriting the tone of the pixel from white to black, and during the period from the 38^{th} period, the tone is maintained at the intermediate tone as represented by “□”.

When the driving of a pixel by the first method is compared with the driving of a pixel by the second method, as can be seen from the driving waveform shown in FIG. 6 and FIG. 7, the number of the frames required for changing the tone value by the first method is smaller than by the second method, and accordingly the screen is rewritten more quickly by the first method than by the second method.

A storage unit 102 has a non-volatile memory, and stores a document file. The storage unit 102 also stores an application program A1 (hereinafter, “first application A1”) for displaying a document corresponding to the document file.

The operation unit 101 has a plurality of buttons used for operating the display apparatus 10. The buttons include a button 101A and a button 101B, which are used for turning a page of the document displayed by the display unit 107. The operation unit 101 also has a button for powering on or off the display apparatus 10.

The communication unit 108 is a communication interface performing wireless communication. The communication unit 108 performs communication according to a communication standard for a wireless local area network (LAN), and transmits information to another apparatus, or receives information transmitted by another apparatus.

The control unit 100 is a microcomputer including a central processing unit (CPU), a read only memory (ROM), and a random access memory (RAM). When the CPU reads a program stored in the ROM and executes the read program by using the RAM as a work area, the operating system in the display apparatus 10 runs, and allows execution of application programs. The present embodiment is described based on the assumption that the operating system is Android®. However, the operating system that runs may be another operating system.

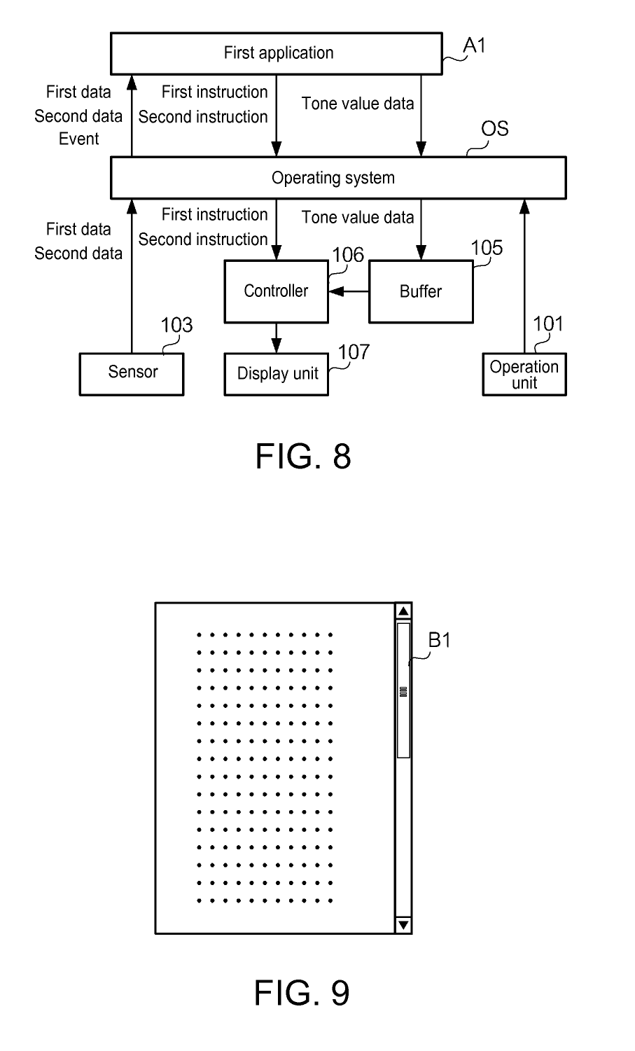

FIG. 8 is a functional block diagram showing the functions of the display apparatus 10. In the present embodiment, the operating system OS runs, and accordingly application programs run on the operating system OS. The operating system OS performs basic operations such as file processing or hardware control. When the operating system OS is running, the power consumption can be reduced by stopping power supply to the display unit 107 and the controller 106. The first application A1, when running on the operating system OS, allows for displaying of the document corresponding to the document file, turning of a page of the displayed document, etc.

Also, the operating system OS sends various types of data to application programs. For example, the operating system OS acquires first data and second data provided by the sensor 103. The operating system OS sends the first data and the second data thus acquired to the first application A1.

The operating system OS also sends an event that is issued based on the acquired second data to the first application A1, and sends an event that is issued according to a pressed button to the first application A1. For example, when the button 101A of the operation unit 101 is pressed, the operating system OS issues a first event notifying that the button 101A is pressed, and when the button 101B is pressed, the operating system OS issues a second event notifying that the button 101B is pressed. When the power button is pressed, the operating system OS issues an event indicating that the power button is pressed.

The operating system OS also generates an event relating to the movement of the pen, based on the second data received from the sensor 103. For example, when the second data indicating the absence of contact is changed to indicate the presence of contact, the operating system OS issues a pen touch event notifying that the stylus pen PE has touched the display unit 107, and when the second data indicating the presence of contact is changed to indicate the absence of contact, the operating system OS issues a pen release event notifying that the stylus pen PE is released from the display unit 107. When both the second data newly received from the sensor 103 and the previously-received second data indicate the presence of contact, the operating system OS issues a contact event notifying that the stylus pen PE is being in contact with the display unit 107. The events issued by the operating system OS are sent to application programs.

Exemplary Operation of Embodiment

Next, a description is given to exemplary operation of the present embodiment with reference to FIG. 9 to FIG. 11.

First, a description is given to an example of the operation for displaying a document on the display unit 107. When the user of the display apparatus 10 performs an operation for opening a document file stored in the storage unit 102, the first application A1 reads the document file from the storage unit 102. The first application A1 also copies the data stored in the first storage area 105A to the second storage area 105B. The first application A1 rasterizes the screen of the page to be displayed on the display unit 107, based on the document file. When the number of the tones that can be expressed on the screen to be displayed is 16, the first application A1 performs color reduction processing, and sets the values in the tone value data of the pixels constituting the screen to be any value within the range from the minimum tone value to the maximum tone value. Upon completion of the rasterizing, the first application A1 writes the data of the tone value of each pixel (tone value data) into the first storage area 105A.

Next, the first application A1 instructs the controller 106 to rewrite the screen. When the first method is selected as the method of driving the display unit 107, the first application A1 outputs, to the controller 106, a first instruction, which is an instruction to drive the display unit 107 by the first method. When the second method is selected as the method of driving the display unit 107, the first application A1 outputs, to the controller 106, a second instruction, which is an instruction to drive the display unit 107 by the second method. These instructions are sent to the controller 106 via the operating system OS.

Upon acquisition of the first instruction, the controller 106 drives the display unit 107 by the first method according to the tone value data written in the first storage area 105A and the second storage area 105B and the first LUT 1061. Here, since the controller 106 drives the pixels by using the first LUT 1061, the rewriting of the screen on the display unit 107 completes in 30 frame periods.

On the other hand, upon acquisition of the second instruction, the controller 106 drives the display unit 107 by the second method according to the tone value data written in the first storage area 105A and the second storage area 105B and the second LUT 1062. Here, since the controller 106 drives the pixels by using the second LUT 1062, the rewriting of the screen on the display unit 107 completes in 45 frame periods. When the rewriting of the screen on the display unit 107 completes, the page of the document and a scroll bar B1 used for scrolling in the page are displayed, as illustrated in FIG. 9.

Upon output of the first instruction or the second instruction, the first application A1 puts the display apparatus 10 into a first power saving mode (first mode). When no user operation is performed for a predetermined period from the previous user operation, the operating system OS puts the display apparatus 10 into a second power saving mode (second mode). When the power button is pressed when the display apparatus 10 is in a normal mode (third mode) which is not a power saving mode or when the display apparatus 10 is in the first power saving mode, the operating system OS puts the display apparatus 10 into the second power saving mode.

Here, in the second power saving mode, a smaller amount of power is consumed than in the first power saving mode. For example, the first power saving mode is a mode in which power supply to the controller 106 and the display unit 107 is stopped, and the second power saving mode is a mode in which power supply to the controller 106, the display unit 107, the buffer 105, the storage unit 102, the sensor 103, and the communication unit 108 is stopped. The normal mode is a mode for supplying power to the storage unit 102, the sensor 103, the buffer 105, the controller 106, the display unit 107, and the communication unit 108.

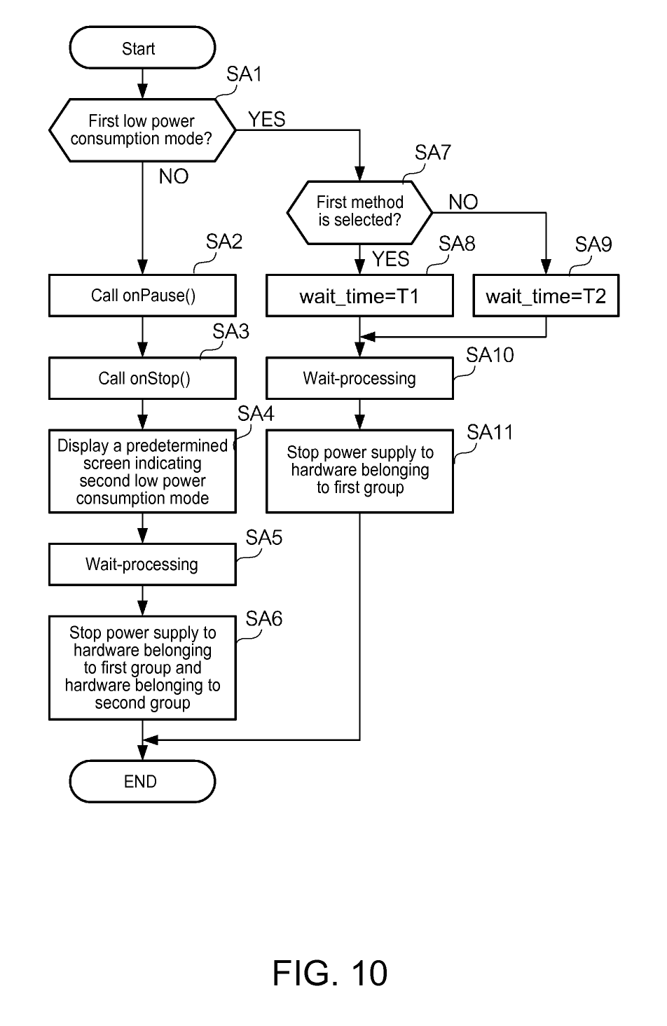

When the mode is changed to the first power saving mode or the second power saving mode, the operating system OS performs the operation shown in FIG. 10. First, the operating system OS determines whether the power saving mode is the first power saving mode or the second power saving mode.

When the power saving mode is the first power saving mode (YES at Step SA1), the operating system OS determines whether the selected driving method is the first method or not. When the selected driving method is the first method (YES at Step SA7), the operating system OS sets wait_time, which is the waiting time for the screen rewriting, to T1 (Step SA8). Note that T1 is the time (rewriting time) from when the controller 106 starts rewriting the screen by the first method to when the rewriting completes. In the present embodiment T1 is 300 msec.

When the selected driving method is the second method (NO at Step SA7), the operating system OS sets wait_time, which is the waiting time for the screen rewriting, to T2 (Step SA9). Note that T2 is the time (rewriting time) from when the controller 106 starts rewriting the screen by the second method to when the rewriting completes. In the present embodiment T2 is 450 msec.

After setting the wait_time, the operating system OS waits until the set wait_time elapses (Step SA10). When the set wait_time elapses, the operating system OS stops power supply to hardware belonging to a first group (Step SA11). In the present embodiment, the hardware belonging to the first group is the controller 106 and the display unit 107.

On the other hand, when the power saving mode is the second power saving mode (NO at Step SA1), the operating system OS first calls callback method onPause( ) (Step SA2), and then calls callback method onStop( ) (Step SA3). In response to the calling for each method, the first application A1 executes the method onPause( ) and the method onStop( ).

Next, the operating system OS performs processing for displaying a predetermined screen indicating the second power saving mode (Step SA4). Specifically, after supplying power to the hardware belonging to the first group, the operating system OS copies the data stored in the first storage area 105A to the second storage area 105B. Next, the operating system OS writes the tone value data obtained by rasterizing the predetermined screen into the first storage area 105A, and sends the first instruction or the second instruction to the controller 106. Note that the predetermined screen may include a character, a picture, a figure, etc., or a screen composed of pixels that are all white, or pixels that are all black. After sending the first instruction or the second instruction, the operating system OS waits until the predetermined time elapses (Step SA5). This waiting time is T1 when the instruction sent to the controller 106 is the first instruction, and T2 when the instruction sent to the controller 106 is the second instruction. Upon completion of the processing at Step SA5, the operating system OS stops power supply to the hardware belonging to the first group and the hardware belonging to a second group (Step SA6). The hardware belonging to the second group is the buffer 105, the storage unit 102, the sensor 103, and the communication unit 108.

According to the present embodiment, the display apparatus 10, after displaying the page of the document by using the first application A1, stops power supply to the hardware belonging to the first group upon elapse of the time required for the rewriting of the screen. Power supply to the hardware belonging to the first group is not stopped until the completion of the rewriting of the screen, and the screen is properly displayed until then. Upon completion of the rewriting, power supply to the hardware belonging to the first group is stopped, which leads to reduction of the power consumption.

Also, according to the present embodiment, the predetermined screen indicating the second power saving mode is displayed when no user operation is performed for a predetermined period from the previous user operation or when the power button of the operation unit 101 is pressed. Accordingly, the user is notified of the switching to the second power saving mode. Also, since the power supply to both the hardware belonging to the first group and the hardware belonging to the second group is suspended when the mode is switched to the second power saving mode, the power consumption is reduced.

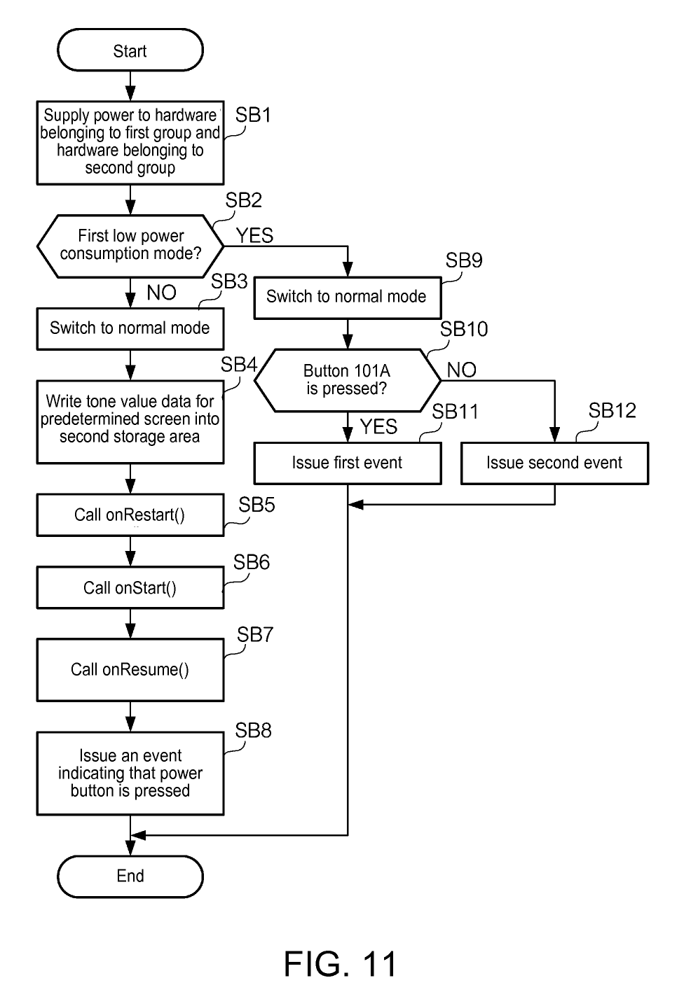

Next, a description is given to operation performed when the mode is switched from the first or the second power saving mode to the normal mode. When the button 101A or the button 101B is pressed when the display apparatus 10 is in the first power saving mode, or when the power button is pressed in the situation where the display apparatus 10 is in the second power saving mode and the first application A1 has not been discarded, the operating system OS performs the operation shown in FIG. 11. Specifically, the operation system OS first supplies power to the hardware belonging to the first group and the hardware belonging to the second group (Step SB1).

Next, the operating system OS determines whether the power saving mode is the first power saving mode or the second power saving mode. When the power saving mode is the first power saving mode (YES at Step SB2), the operating system OS switches to the normal mode (Step SB9). Next, the operating system OS determines what button is pressed. When the pressed button is the button 101A (YES at Step SB10), the operating system OS issues the first event to the first application A1 (Step SB11), and when the pressed button is the button 101B (NO at Step SB10), the operating system OS issues the second event to the first application A1 (Step SB12).

Upon acquisition of the first event, the first application A1 rasterizes the screen of the page having a page number that is greater by one than the page number of the page that is being displayed at the moment, copies the tone value data stored in the first storage area 105A to the second storage area 105B, and writes the tone value data of each pixel obtained by the rasterizing into the first storage area 105A. On the other hand, upon acquisition of the second event, the first application A1 rasterizes the screen of the page having a page number that is smaller by one than the page number of the page that is being displayed at the moment, copies the tone value data stored in the first storage area 105A to the second storage area 105B, and writes the tone value data of each pixel obtained by the rasterizing into the first storage area 105A.

Next, the first application A1 sends, to the controller 106, the first instruction or the second instruction, depending on the selected driving method. When the controller 106 having acquired the first instruction or the second instruction drives the display unit 107, when the pressed button is the button 101A, the page having a page number that is greater by one than the page being displayed at the moment is displayed, and when the pressed button is the button 101B, the page having a page number that is smaller by one than the page being displayed at the moment is displayed.

On the other hand, when the power saving mode is the second power saving mode (NO at Step SB2), the operating system OS first switches to the normal mode (Step SB3), rasterizes the predetermined screen that is being displayed, and writes the tone value data of each pixel of the predetermined screen into the second storage area 105B (Step SB4). Next, the operating system OS, after calling the callback method onRestart( ) at Step SB5, calls the callback method onStart( ) at Step SB6, and then calls the callback method onResume( ) at Step SB7. The operating system OS also issues an event indicating that the power button is pressed, to the first application A1 (Step SB8).

Upon acquisition of this event, the first application A1 rasterizes the screen of the page that was being displayed before the switching to the second power saving mode, and writes the tone value data of each pixel of the rasterized page into the first storage area 105A. Next, the first application A1 sends, to the controller 106, the first instruction or the second instruction, depending on the selected driving method. When the controller 106 having acquired the first instruction or the second instruction drives the display unit 107, the predetermined screen that is being displayed is rewritten with the screen that was being displayed before the switching to the second power saving mode.

As described above, in the present embodiment, when an operation for changing the page to be displayed is performed in the situation where the display apparatus 10 is in the first power saving mode for stopping power supply to the display unit 107, the processing for re-rendering the screen that was being displayed is omitted, and therefore the power consumption can be reduced. Also, in the present embodiment, when the power button is pressed in the situation where the display apparatus 10 is in the second power saving mode, the predetermined screen that is being displayed is rewritten with the screen that was being displayed before the switching to the second power saving mode, and the user is notified of the recovering from the power saving mode to the normal mode.

### Second Embodiment

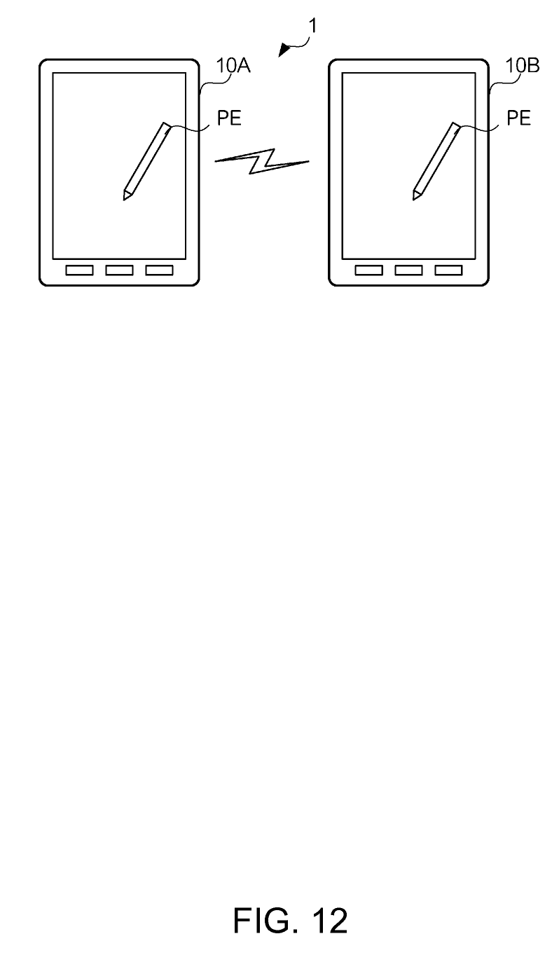

Next, a description is given to a second embodiment of the invention. FIG. 12 is a diagram showing apparatuses constituting a display system 1 according to an embodiment of the invention. The display system 1 according to the second embodiment of the invention includes a display apparatus 10A and a display apparatus 10B. The display apparatuses 10A and 10B have the hardware configuration as the display apparatus 10 according to the first embodiment. Note, however, that the display apparatuses 10A and 10B have, in addition to the functions of the display apparatus 10, the function of synchronizing the displays. The display apparatus 10B displays a screen according to the information transmitted by the display apparatus 10A such that the screen is displayed in synchronization with the screen displayed by the display apparatus 10A.

Next, a description is given to exemplary operation of the second embodiment. Note that the following description of the exemplary operation is based on the assumption that the same document file is stored in the display apparatuses 10A and 10B.

First, when the user of the display apparatus 10A performs an operation for opening the document file stored in the storage unit 102, in the same manner as with the first embodiment, the display apparatus 10A displays a page of the document and a scroll bar B1 used for scrolling in the page. After displaying the document, the display apparatus 10A transmits a synchronization instruction to the display apparatus 10B. The synchronization instruction includes the document file name of the document being displayed, the page number of the page being displayed, and instructs synchronization of the screens.

The display apparatus 10B, upon receiving the synchronization instruction, acquires the document file having the document file name included in the synchronization instruction from the storage unit 102, rasterizes the page having the page number included in the synchronization instruction, and displays the page on the display unit 107. The display apparatus 10B displays the same screen as the screen displayed by the display apparatus 10A. After displaying the screen, the display apparatuses 10A and 10B switch to the first power saving mode.

Next, when the user of the display apparatus 10A presses the button 101A or the button 101B, the display apparatus 10A switches to the normal mode, and displays the page having a page number that is greater or smaller by one than the page that is being displayed. The display apparatus 10A also sends a synchronization instruction to the display apparatus 10B. The synchronization instruction includes the document file name of the document being displayed, the page number of the page being displayed, and instructs synchronization of the screens.

When the display apparatus 10B is in the first power saving mode at the time of receiving the synchronization instruction, the display apparatus 10B supplies power to the hardware belonging to the first group and the hardware belonging to the second group, and switches to the normal mode. After copying the data stored in the first storage area 105A to the second storage area 105B, the display apparatus 10B specifies the page to display, based on the document file name and the page number included in the synchronization instruction, and writes the screen data of the specified page into the first storage area 105A. In the display apparatus 10B, when the controller 106 drives the display unit 107, the display apparatus 10B displays the same page as the page displayed on the display apparatus 10A.

As described above, according to the present embodiment, even when a display apparatus is in the power saving mode, the mode can be switched from the power saving mode to the normal mode, and the screen displayed on one display apparatus can be displayed on another display apparatus.

### Modification Examples

Although embodiments of the invention are described above, the invention is not limited to the above-described embodiments, and may be implemented in other various modes. For example, the invention may be implemented by modifying the above-described embodiments in the manner described below. Note that the embodiments described above and the modification examples shown below may be combined with each other.

In the embodiments described above, in the case of switching to the first power saving mode, Step SA7 to Step SA11 are performed by the operating system OS. However, this is not essential. For example, the first application A1 may perform Step SA7 to Step SA11 after outputting the first instruction or the second instruction and putting the display apparatus 10 into the first power saving mode.

In the embodiments described above, in the case of switching to the second power saving mode, Step SA4 to Step SA6 are performed by the operating system OS. However, this is not essential. For example, Step SA4 to Step SA6 may be performed within the method onPause( ) or onStop( ).

In the embodiments described above, when the button 101A or the button 101B is pressed under the situation where the mode is the first power saving mode, the operating system OS causes the switching to the normal mode at Step SB9. However, this is not essential.

For example, when the button 101A or the button 101B is pressed in the situation where the mode is the first power saving mode, the operating system OS may perform Step SB5 to Step SB7 and cause the switching to the normal mode within any of the functions onRestart( ), onStart( ), and onResume( ).

Also, in the embodiments described above, when the power button is pressed under the situation where the mode is the second power saving mode, the operating system OS causes the switching to the normal mode at Step SB3. However, the first application A1 may cause the switching to the normal mode by using any of the functions onRestart( ), onStart( ), and onResume( ), and display the same screen as the screen that was being displayed at the time of the switching to the second power saving mode.

In the embodiments described above, the recovering to the normal mode occurs when the button 101A or the button 101B is operated in the situation where the mode is the first power saving mode. However, even when another button is pressed or when an event relating to the stylus pen PE is issued, power may be supplied to the hardware belonging to the first group so that the recovering from the first power saving mode to the normal mode occurs.

In the embodiments described above, the switching from the first power saving mode to the normal mode occurs when the button 101A or the button 101B of the operation unit 101 is pressed. However, the configuration for the switching from the first power saving mode to the normal mode is not limited to this configuration. For example, it is possible that a software key corresponding to the button 101A and a software key corresponding to the button 101B are displayed, and when these keys are touched by the stylus pen PE, the switching from the first power saving mode to the normal mode occurs, power is supplied to the hardware belonging to the first group, and the page to be displayed is rewritten.

In the embodiments described above, the switching from the normal mode to the first power saving mode occurs when a predetermined time has elapsed since the rewriting of the screen. However, the configuration for the switching from the normal mode to the first power saving mode is not limited to this configuration. For example, the operating system OS may cause the switching from the normal mode to the first power saving mode when the CPU utilization of the first application A1 decreases to be no greater than a predetermined threshold value.

In the embodiments described above, power supply to the controller 106 and the display unit 107 is stopped at the switching to the first power saving mode. However, this is not essential, and for example, power supply to the buffer 105 may be stopped as well.

In this modification example, it is possible that the data stored in the second storage area 105B is written into the storage unit 102 before power supply to the buffer 105 is stopped, and the data thus stored in the storage unit 102 is written into the second storage area 105B when power supply to the buffer 105 is restarted.

In the embodiments described above, a predetermined screen is displayed when the mode is the second power saving mode. However, this is not essential. For example, when the switching to the second power saving mode occurs, an image indicating the second power saving mode may be displayed on a portion of the display area with the page that has been displayed being maintained, and when the switching from the second power saving mode to the normal mode occurs, the image indicating the second power saving mode may be removed.

In the embodiments described above, when an operation for turning a page is performed, only one page is turned at a time and a new page is displayed. However, the number of pages that can be turned at a time is not limited to one. For example, when an operation for moving a knob of the scroll bar B1 is performed, a number of pages corresponding to the amount of the movement of the knob may be turned so that a new page is displayed.

The embodiment described above has a unipolar driving structure, in which either the first voltage or the second voltage is applied during a single frame period. However, a bipolar driving structure may be adopted, in which both the first voltage and the second voltage can be applied during a single frame period.

Programs that are executed by the display apparatus 10 may be installed from a state of being stored on a computer-readable recording medium such as a magnetic recording medium (magnetic tape, magnetic disk (HDD (Hard Disk Drive), FD (Flexible Disk)), etc.), an optical recording medium (optical disc etc.), a magneto-optical recording medium, or a semiconductor memory. The programs may also be installed by being downloaded via a communication line.

This application claims priority from Japanese Patent Application No. 2014-106396 filed in the Japanese Patent Office on May 22, 2014, the entire disclosure of which is hereby incorporated by reference in its entirely.

What is claimed is:

1. A display apparatus comprising:
a memory display unit;
an operation unit operated by a user; and
a control unit that executes an operating system and an application for displaying a document,
wherein a mode is selected from among a third mode in which power is supplied to the memory display unit, a first mode in which power is not supplied to the memory display unit, and a second mode in which power supply to the memory display unit is not supplied and in which a power consumption is smaller than in the first mode,
the operating system, when an operation for replacing a page of the document displayed on the memory display unit is performed on the operation unit in the first mode, selects the third mode and sends an event corresponding to the operation to the application, and
the application, upon acquisition of the event, performs processing for displaying another page on the memory display unit.

2. The display apparatus according to claim 1,
wherein, when an operation for switching to the third mode is performed on the operation unit in the second mode, the third mode is selected.

3. A display apparatus comprising: a memory display unit; an operation unit operated by a user; a control unit that executes an operating system and an application for displaying a document,
wherein a mode is selected from among a third mode in which power is supplied to the memory display unit, a first mode in which power supply to the memory display unit is stopped, and a second mode in which power supply to the memory display unit is stopped and in which power consumption is smaller than in the first mode,
the operating system, when an operation for switching from the first mode or the second mode to the third mode is performed on the operation unit, selects the third mode and supplies power to the memory display unit, and calls a callback function of the application,
the operating system, when an operation for replacing a page of the document displayed on the memory display unit is performed, sends an event corresponding to the operation to the application,
the application, when the mode at the time the callback function is called is the second mode, performs processing for displaying a screen that was being displayed on the memory display unit when the second mode was selected, and
the application, when the mode at the time the callback function is called is the first mode, acquires the event, and performs processing for displaying another page on the memory display unit, instead of performing processing for displaying a screen that was being displayed on the memory display unit when the first mode was selected.

4. The display apparatus according to claim 1,
wherein switching from the third mode to the first mode is performed after the processing for displaying another page on the memory display unit is performed.

5. The display apparatus according to claim 4,
wherein switching from the third mode to the first mode is performed when predetermined time has elapsed since the processing for displaying another page on the memory display unit was performed, the predetermined time being time required for displaying the other page.

6. The display apparatus according to claim 4,
wherein a plurality of methods are provided for replacing a page displayed on the memory display unit, each method being different in rewriting time, and the predetermined time is changed according to a method selected from among the plurality of method.

7. The display apparatus according to claim 1,
wherein,
in the first mode, power supply to the control unit is stooped, and
in the second mode, power supply to the control unit and a sensor of the display apparatus is stopped.

8. A display apparatus comprising: a memory display unit; an operation unit operated by a user; a control unit that executes an operating system and an application for displaying a document,
wherein a mode is selected from among a third mode in which power is supplied to the memory display unit, a first mode in which power supply to the memory display unit is stopped, and a second mode in which power supply to the memory display unit is stopped and in which power consumption is smaller than in the first mode, and
the operating system, when an operation for replacing a page of the document displayed on the memory display unit is performed on the operation unit in the first mode, selects the third mode and supplies power to the memory display unit, and performs processing for displaying a page corresponding to the operation, without displaying again the page that was being displayed before the switching to the third mode.

9. A display method comprising:
selecting a mode from among a third mode in which power is supplied to a memory display unit, a first mode in which power supply to the memory display unit is stopped, and a second mode in which power supply to the memory display unit is stopped and in which power consumption is smaller than in the first mode,
wherein an operating system, when an operation for replacing a page of a document displayed on the memory display unit is performed on an operation unit in the first mode, selects the third mode and supplies power to the memory display unit, and sends an event corresponding to the operation to an application,
the operating system, when an operation for switching to the third mode is performed on the operation unit in the second mode, selects the third mode and supplies power to the memory display unit, and
an application for displaying a document, upon acquisition of the event, performs processing for displaying another page on the memory display unit.
